(19) United States
(12) Patent Application Publication
(10) Pub. No.: US 2022/0393278 A1
(43) Pub. Date: Dec. 8, 2022

(54) BATTERY MODULE AND BATTERY PACK INCLUDING THE SAME

(71) Applicant: LG ENERGY SOLUTION, LTD., Seoul (KR)

(72) Inventors: Sunghwan JANG, Daejeon (KR); Hyemi JUNG, Daejeon (KR); Junyeob SEONG, Daejeon (KR); Kwangmo KIM, Daejeon (KR)

(73) Assignee: LG ENERGY SOLUTION, LTD., Seoul (KR)

(21) Appl. No.: 17/830,892

(22) Filed: Jun. 2, 2022

(30) Foreign Application Priority Data
Jun. 7, 2021 (KR) 10-2021-0073330

(51) Int. Cl. H01M 50/209; H01M 50/224; H01M 50/231; H01M 50/227; H01M 10/653; H01M 10/658

(52) U.S. Cl. CPC H01M 50/209; H01M 50/224; H01M 50/231; H01M 50/227; H01M 10/653; H01M 10/658

(57) ABSTRACT

A battery module includes a battery cell stack in which a plurality of battery cells are stacked; a module frame for housing the battery cell stack; and a metal sheet positioned between the battery cell stack and the module frame.

### TECHNICAL FIELD

The present disclosure relates to a battery module and a battery pack including the same, and more particularly, to a battery module having improved module structure and a battery pack including the same.

### BACKGROUND

Along with the increase of the technological development and demand for a mobile device, demand for a secondary battery as an energy source is increasing rapidly, and accordingly, many researches on the battery capable of meeting various demands are being performed.

A secondary battery has attracted considerable attention as an energy source for power-driven devices, such as an electric bicycle, an electric vehicle, and a hybrid electric vehicle, as well as an energy source for mobile devices, such as a mobile phone, a digital camera, and a laptop computer.

Recently, along with a continuous rise of the necessity for a large-capacity secondary battery structure, including the utilization of the secondary battery as an energy storage source, there is a growing demand for a battery pack of a multi-module structure which is an assembly of battery modules in which a plurality of secondary batteries are connected in series or in parallel.

Meanwhile, when a plurality of battery cells are connected in series or in parallel to configure a battery pack, a method of configuring a battery module composed of at least one battery cell and then adding other components to at least one battery module to configure a battery pack is common.

A battery module configured to gather a plurality of battery cells can add up heat generated from the large number of battery cells in a narrow space, so that the temperature can rise more quickly and excessively. In other words, a battery module in which a large number of battery cells are stacked can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases. Further, when the temperature of the battery module exceeds a certain temperature, the module frame melts down and the structure of the battery module collapses. When a thermal runaway phenomenon occurs, it becomes easier for the flame to propagate to adjacent battery modules, thus increasing the possibility of fire or explosion.

FIG. 1 is a diagram showing a conventional battery module. FIG. 2 is a cross-sectional view taken along the cutting line A-A of FIG. 1.

Referring to FIGS. 1 and 2, the battery module 1 includes a battery cell stack 12 in which a plurality of battery cells 11 are stacked, a module frame 20 that warps the upper surface, lower surface and both side surfaces of the battery cell stack 12, and an end plate 50 positioned on the front and rear surfaces of the battery cell stack 12.

When a thermal event such as a thermal runaway phenomenon occurs inside the battery module 1, the module frame 20 may be melted to collapse the structure of the battery module 10 if the temperature generated by the thermal runaway phenomenon is higher than the melting point of the material constituting the module frame 20. For example, if the temperature generated by a thermal event is 300° C. or more, the module frame 20 formed of an aluminum material may be melted to collapse the structure of the battery module 1. In this case, the thermal runaway propagation reaction to adjacent battery modules 1 is promoted due to the structural collapse of the battery module 1, thereby increasing the risk of fire and explosion.

That is, even if thermal runaway occurs in any one battery module, it is necessary to design a model that does not lead to fire or explosion of the battery module and battery pack itself.

### DETAILED DESCRIPTION OF THE INVENTION

### Technical Problem

It is an object of the present disclosure to provide a battery module that suppresses the thermal runaway propagation reaction between battery modules due to the metal sheet positioned between the module frame and the battery cell stack, and a battery pack comprising the same.

However, the technical problem to be solved by embodiments of the present disclosure is not limited to the above-described problems, and can be variously expanded within the scope of the technical idea included in the present disclosure.

### Technical Solution

According to one aspect of the present disclosure, there is provided a battery module comprising: a battery cell stack in which a plurality of battery cells are stacked; a module frame for housing the battery cell stack; and a metal sheet positioned between the battery cell stack and the module frame.

A melting point of the metal sheet may be higher than a melting point of the module frame.

The metal sheet may include a metal material having a melting point of 1000 degrees Celsius or more.

An insulating resin may be coated onto a surface of the metal sheet, or an insulating film may be attached to the surface of the metal sheet.

The metal sheet may be positioned in correspondence with at least one of the upper surface, the lower surface, and opposite side surfaces of the battery cell stack.

An end plate may be at each of a front surface and rear surface of the battery cell stack and a busbar frame may be positioned between the battery cell stack and the end plate, wherein the metal sheet may be formed integrally with the busbar frame or is attached to the busbar frame.

The metal sheet may be integrated with an injection object or may be attached with an injection object.

The module frame may include an upper frame corresponding to an upper surface of the battery cell stack, and a U-shaped frame that wraps a lower surface and opposite side surfaces of the battery cell stack.

The metal sheet is positioned on the upper surface of the battery cell stack, and the upper frame may be laminated and positioned on the metal sheet laminated on the upper surface of the battery cell stack.

The battery module may further include a thermal conductive resin layer between the module frame and the metal sheet.

According to another aspect of the present disclosure, there is provided a battery pack comprising the above-mentioned at least one battery module, and a pack case for packaging the at least one battery module.

The metal sheet may be between the module frame and an upper surface and opposite side surfaces of the battery cell stack.

### Advantageous Effects

According to embodiments of the present disclosure, a metal sheet can be positioned between the module frame and the battery cell stack to cut off the heat propagation reaction between the battery modules and improve the stability of the battery module.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a diagram showing a conventional battery module;

FIG. 2 is a cross-sectional view taken along the cutting line A-A of FIG. 1;

FIG. 3 is a diagram showing an exploded view in which a battery module according to an embodiment of the present disclosure is assembled;

FIG. 4 is a cross-sectional view of the battery module of FIG. 3 vertically cut from an upper surface to a lower surface;

FIG. 5 is a cross-sectional view showing a modification of the battery module described in FIG. 4;

FIG. 6 is an exploded view of a battery module according to another embodiment of the present disclosure;

FIG. 7 is a cross-sectional view vertically cut from the upper surface to the lower surface of the battery module according to another embodiment of the present disclosure; and

FIG. 8 is a cross-sectional view showing a modification of the battery module described in FIG. 7.

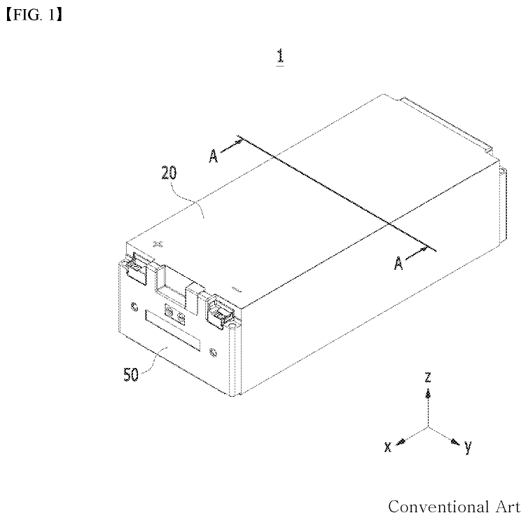

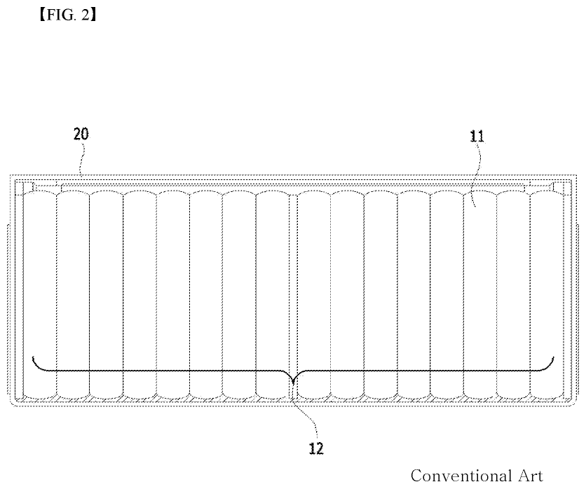

### DETAILED DESCRIPTION OF THE EMBODIMENTS

Hereinafter, various embodiments of the present disclosure will be described in detail with reference to the accompanying drawings so that those skilled in the art can easily carry out them. The present disclosure can be modified in various different ways, and is not limited to the embodiments set forth herein.

A description of parts not related to the description will be omitted herein for clarity, and like reference numerals designate same or like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed “on” or “above” the reference portion toward the opposite direction of gravity.

Further, throughout the specification, when a portion is referred to as “including” or “comprising” a certain component, it means that the portion can further include other components, without excluding the other components, unless otherwise stated.

Further, throughout the specification, when referred to as “planar”, it means when a target portion is viewed from the upper side, and when referred to as “cross-sectional”, it means when a target portion is viewed from the side of a cross section cut vertically.

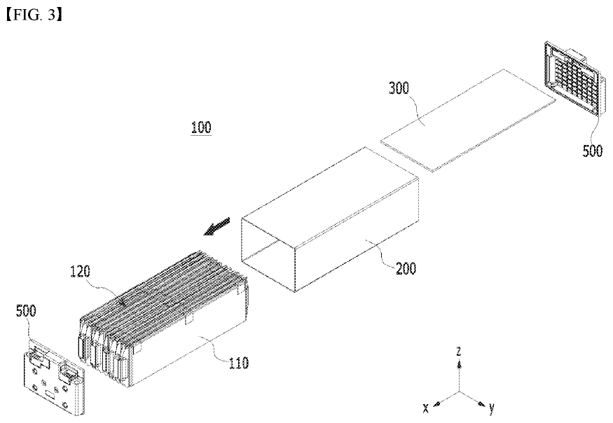

FIG. 3 is a diagram showing an exploded view in which a battery module according to an embodiment of the present disclosure is assembled. FIG. 4 is a cross-sectional view of the battery module of FIG. 3 vertically cut from an upper surface to a lower surface.

Referring to FIGS. 3 and 4, a battery module 100 according to an embodiment of the present disclosure includes a battery cell stack 120 in which a plurality of battery cells 110 are stacked, a module frame 200 that wraps the upper surface, the lower surface and both side surfaces of the battery cell stack 120, end plates 500 that wrap the front and rear surfaces of the battery cell stack 120, and a metal sheet 300 positioned between the battery cell stack 120 and the module frame 200.

The module frame 200 may be a mono frame. The module frame 200 may be formed of an aluminum material. In the case of the module frame 200 formed of an aluminum material, it can be melted at a high temperature to collapse the structure of the battery module 100.

The metal sheet 300 may be positioned between the battery cell stack 120 and the module frame 200. The metal sheet 300 may be positioned in correspondence with one surface of the battery cell stack 120. Referring to the figures, the metal sheet 300 may be positioned in correspondence with the upper surface of the battery cell stack 120. However, the metal sheet 300 is not positioned so as to correspond only to the upper surface of the battery cell stack 120. Although not shown in the figure, it can be positioned in correspondence with any one of the side surface, lower surface, front and rear surfaces of the battery cell stack 120.

The metal sheet 300 may correspond to the shape of one surface of the battery cell stack 120 positioned in correspondence with the metal sheet 300.

The metal sheet 300 may include a material having a high melting point. The metal sheet 300 may include a material having a higher melting point than the module frame 200. The metal sheet 300 may include a material having a melting point of 1000° C. or more. For example, the metal sheet 300 may be a SUS thin plate, but is not limited thereto. If it is a material having a melting point of 1000° C. or higher, one or more thereof may be used. Therefore, even if the module frame 200 is melted at a high temperature, the metal sheet 300 is not melted, whereby the metal sheet 300 can prevent the structural collapse of the battery module 100. Further, the metal sheet 300 may prevent the flame generated in the battery cell stack 120 from propagating to the battery module adjacent to the battery module in which flame is generated. That is, the metal sheet 300 can suppress a thermal runaway propagation phenomenon between the battery modules 100.

The metal sheet 300 may include an insulating material. In order to secure the insulation property of the metal sheet 300, various insulation treatment processes can be performed. For example, an insulating resin may be coated onto the surface of the metal sheet 300 or an insulating film may be attached thereto.

The metal sheet 300 may be positioned integrally with an injection object, or an injection object may be attached to the metal sheet 300. The objection object may be a Busbar Frame Assembly (BFA).

The battery module 100 can be formed by positioning the battery cell stack 100 in the module frame 200, inserting the metal sheet 300 between the module frame 200 and the battery cell stack 100, and then mounting the end plate 500 on the front and rear surfaces of the battery cell stack 100.

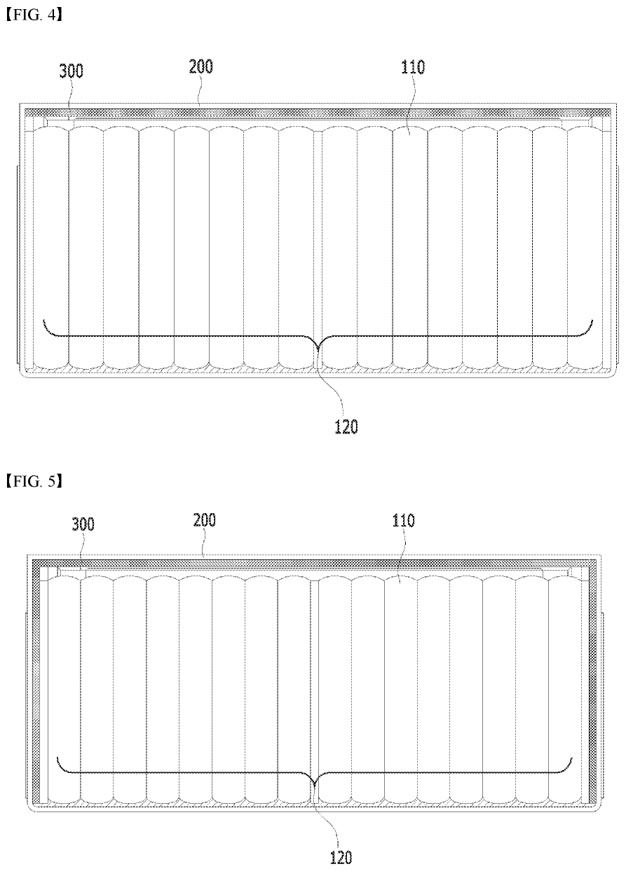

FIG. 5 is a cross-sectional view showing a modification of the battery module described in FIG. 4.

Referring to FIG. 5, the metal sheet 300 is positioned so as to correspond to the upper surface and both side surfaces of the battery cell stack 120 as well as the upper surface of the battery cell stack 120. However, the position of the metal sheet 300 is not limited to that shown in FIG. 5. Although not shown in the figure, the metal sheet 300 may be positioned so as to correspond to the front and rear surfaces of the battery cell stack 120.

As the area where the metal sheet 300 is located is larger, the overall structure of the battery module 100 may be better maintained even if the module frame 200 is melted at a high temperature. Therefore, as the area in which the metal sheet 300 is located is larger, the effect of suppressing the heat propagation chain reaction between the battery modules 100 may be further improved.

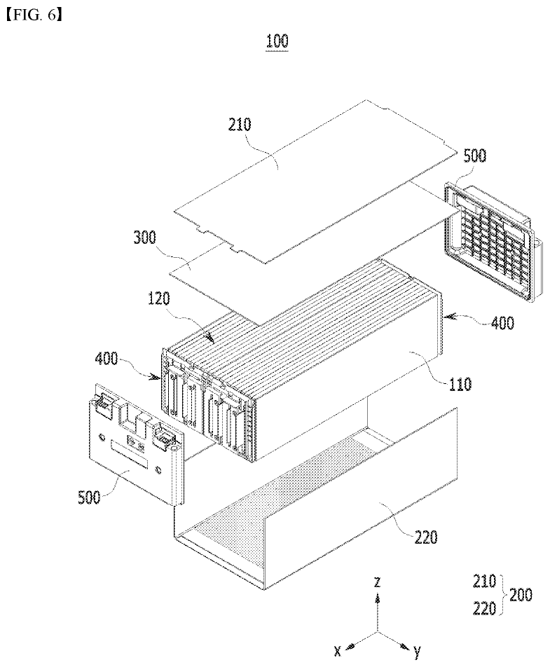

FIG. 6 is an exploded view of a battery module according to another embodiment of the present disclosure.

Referring to FIG. 6, the battery module 100 according to another embodiment of the present disclosure may include a battery cell stack 120 in which a plurality of battery cells 110 are stacked, a module frame 200 that wraps the upper surface, the lower surface and both side surfaces of the battery cell stack 120, end plates 500 that wrap the front and rear surfaces of the battery cell stack 120, and a metal sheet 300 positioned between the battery cell stack 120 and the module frame 200.

The module frame 200 may include an upper frame 210 corresponding to the upper surface of the battery cell stack 120, and a U-shaped frame 220 that wraps the lower surface and both side surfaces of the battery cell stack 120.

The battery module 100 may be configured such that the battery cell stack 120 is positioned in a U-shaped frame 220, the metal sheet 300 is laminated and positioned on the upper surface of the battery cell stack 120, and then the upper frame 210 is stacked on the upper surface of the metal sheet 300. In the manufacturing process of the battery module 100 when the module frame 200 includes the U-shaped frame 220, the metal sheet 300 is stacked so as to correspond to the upper surface of the battery cell stack 120, whereas in the manufacturing process of the battery module 100 when the module frame 200 is a mono frame, the battery cell stack 120 is positioned on the module frame 200 and then a process of inserting the metal sheet 300 should be further performed. Therefore, when the module frame 200 is a U-shaped frame 220, the battery module manufacturing process is simpler than when the module frame 200 is a mono frame, thereby being able to reduce material costs and improve the process efficiency.

However, although not shown in the figure, even if the module frame 200 includes the U-shaped frame 220, the metal sheet 300 is not positioned so as to correspond only to the upper frame 210. The metal sheet 300 can be positioned so as to correspond to at least one surface of the battery cell stack 120. For example, the metal sheet 300 may be laminated on the lower part of the U-shaped frame 220, and the battery cell stack 120 may be positioned on the metal sheet 300 laminated on the lower part of the U-shaped frame 220. Alternatively, the metal sheet 300 can also be inserted and positioned between the battery cell stack 120 and the module frame 200 with respect to the battery cell stack 120 and the module frame 200 to which the U-shaped frame 220 and the upper frame 210 are mounted. The metal sheet 300 may be positioned so as to correspond to the front and rear surfaces of the battery cell stack 120.

FIG. 7 is a cross-sectional view vertically cut from the upper surface to the lower surface of the battery module according to another embodiment of the present disclosure.

Referring to FIG. 7, the battery module 100 according to another embodiment of the present disclosure may include a battery cell stack 120 in which a plurality of battery cells 110 are stacked, a module frame 200 that wraps the upper surface, the lower surface and both side surfaces of the battery cell stack 120, a metal sheet 300 positioned between the battery cell stack 120 and the module frame 200, and a thermal conductive resin layer 600 positioned between the metal sheet 300 and the module frame 200.

The thermal conductive resin layer 600 may be positioned between the metal sheet 300 and the module frame 200 to adhere and fix the metal sheet 300 and the module frame 200 to each other.

The thermal conductive resin layer 600 may be formed by coating a thermal conductive resin on one surface of the metal sheet 300 positioned in correspondence with the module frame 200. Specifically, the thermal conductive resin layer 600 can be formed by injecting a thermal conductive resin into the module frame 200 on which the metal sheet 300 is mounted. Alternatively, the thermal conductive resin layer 600 is formed by coating a thermal conductive resin onto one surface of the metal sheet 300, and then laminating the module frame 200 on one surface of the metal sheet 300 coated with the thermally conductive resin.

Due to the presence of the thermal conductive resin layer 600, connection between the metal sheet 300 and the module frame 200 becomes firm and the position of the metal sheet 300 can be fixed, so that the durability of the battery module 100 can be improved.

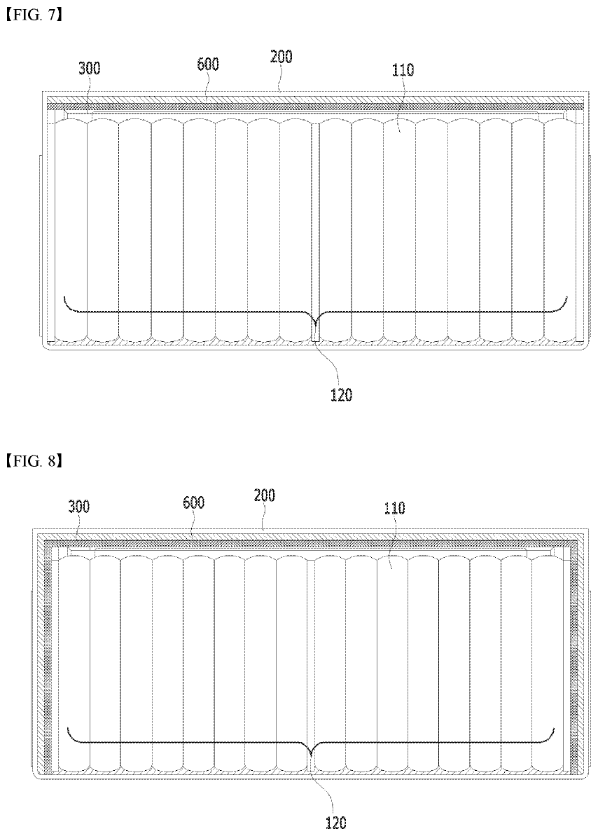

FIG. 8 is a cross-sectional view showing a modification of the battery module described in FIG. 7.

Referring to FIG. 8, the metal sheet 300 of the battery module 100 according to another embodiment of the present disclosure can be positioned so as to corresponds to at least one of the upper surface, lower surface, and both side surfaces of the battery cell stack 120, and can be positioned between the battery cell stack 120 and the module frame 200. The thermal conductive resin layer 600 may be located only on a surface corresponding to one surface of the metal sheet 300, and may be positioned between the metal sheet 300 and the module frame 200. In the figure, the metal sheet 300 is positioned so as to correspond to the upper part and both side surfaces of the battery cell stack 120, but is not limited thereto.

As the area in which the metal sheet 300 is located is larger, the effect of suppressing the thermal runaway propagation reaction between the battery modules 100 can be further improved. As the area in which the thermal conductive resin layer 600 is located is larger, the area where connection between the metal sheet 300 and the module frame 200 is formed also increases, so that the durability of the battery module 100 can improved.

Meanwhile, one or more battery modules according to an embodiment of the present disclosure can be packaged in a pack case to form a battery pack.

The above-mentioned battery module and the battery pack including the same can be applied to various devices. Such a device may be applied to a vehicle means such as an electric bicycle, an electric vehicle, or a hybrid vehicle, but the present disclosure is not limited thereto, and is applicable to various devices that can use a battery module and the battery pack including the same, which also belongs to the scope of the present disclosure.

Although preferred embodiments of the present disclosure have been shown and described above, the scope of the present disclosure is not limited thereto, and numerous other variations and modifications can be made by those skilled in the art using the basic principles of the invention defined in the appended claims, which also falls within the spirit and scope of the invention.

### DESCRIPTION OF REFERENCE NUMERALS

100: battery module
110: battery cell
120: battery cell stack
200: module frame
300: metal sheet
500: end plate
600: thermal conductive resin layer

1. A battery module comprising:
a battery cell stack in which a plurality of battery cells are stacked;
a module frame for housing the battery cell stack; and
a metal sheet positioned between the battery cell stack and the module frame.

2. The battery module of claim 1, wherein:
a melting point of the metal sheet is higher than a melting point of the module frame.

3. The battery module of claim 2, wherein:
the metal sheet comprises a metal material having a melting point of 1000 degrees Celsius or more.

4. The battery module of claim 1, wherein:
an insulating resin is coated onto a surface of the metal sheet, or an insulating film is attached to the surface of the metal sheet.

5. The battery module of claim 1, wherein:
the metal sheet is positioned in correspondence with at least one of the upper surface, the lower surface, and opposite side surfaces of the battery cell stack.

6. The battery module of claim 1,
further comprising an end plate at each of a front surface and rear surface of the battery cell stack and a busbar frame positioned between the battery cell stack and the end plate,
wherein the metal sheet is formed integrally with the busbar frame or is attached to the busbar frame.

7. The battery module of claim 1, wherein:
the module frame comprises an upper frame corresponding to an upper surface of the battery cell stack, and a U-shaped frame that wraps a lower surface and opposite side surfaces of the battery cell stack.

8. The battery module of claim 7, wherein:
the metal sheet is positioned on the upper surface of the battery cell stack, and
the upper frame is laminated and positioned on the metal sheet laminated on the upper surface of the battery cell stack.

9. The battery module of claim 1,
further comprising a thermal conductive resin layer between the module frame and the metal sheet.

10. A battery pack comprising:
at least one battery module of claim 1, and
a pack case for packaging the at least one battery module.

11. The battery module of claim 1, wherein the metal sheet is between the module frame and an upper surface and opposite side surfaces of the battery cell stack.

12. The battery module of claim 11, further comprising a thermal conductive resin layer between the module frame and the metal sheet.

13. The battery module of claim 12, further comprising an insulating resin coated onto a surface of the metal sheet or attached to the surface of the metal sheet.
